(19) United States
(12) Patent Application Publication
(10) Pub. No.: US 2025/0367939 A1
(43) Pub. Date: Dec. 4, 2025

(54) INK CONDITIONER FOR AN INKJET PRINTER

(71) Applicant: BOBST MEX SA, Mex (CH)

(72) Inventor: Walter URECH, Seengen (CH)

(73) Assignee: BOBST MEX SA, Mex (CH)

(21) Appl. No.: 18/874,204

(22) PCT Filed: Aug. 29, 2023
(86) PCT No.: PCT/EP2023/073615

§ 371 Date: Dec. 12, 2024

(30) Foreign Application Priority Data
Sep. 14, 2022 (EP) 22195679.0

(51) Int. Cl. B41J 2/175; B41J 2/195

(52) U.S. Cl. CPC B41J 2/17596; B41J 2/195

(57) ABSTRACT

The invention relates an ink conditioner (14) for an inkjet printer, comprising a main body (18) with an ink damping cavity (24), the ink conditioner (14) further comprising a heat transfer element (26), at least one ink inlet (28) and at least one ink outlet (34), wherein the main body (18), the heat transfer element (26), the at least one ink inlet (28) and the at least one ink outlet (34) consist of the same material and form a single piece.

The invention relates to an ink conditioner for an inkjet printer.

Inkjet printers are typically used to digitally print various products, such as labels, textiles, ceramic tiles and many more, by dispensing small ink droplets through nozzles of a printing head.

In order to achieve consistent and high-quality prints, the ink parameters, such as the ink viscosity, the ink flow rate and the ink pressure, have to be controlled precisely. If the ink viscosity is too high and/or the ink meniscus pressure too low, the ink might not be able to exit the printing head nozzles. In contrast, a too low ink viscosity or a too high meniscus pressure may result in formation of satellite droplets and overall lower print quality. Furthermore, when performing inkjet printing on porous substrates, the resulting printing dot is influenced by viscosity dependent spreading of the ink on the substrate and penetration of the ink into the substrate.

Especially in high-throughput industrial inkjet printing, the ink control is often complex and requires a sophisticated ink management system with a manifold that distributes the ink to the single print heads and/or controls the ink temperature such that a desired viscosity is reached.

Furthermore, in advanced inkjet machines, ink conditioners are applied that enable precise control of the ink parameters directly at the print head inlet and/or outlet. Such ink conditioners may comprise means for measuring and adjusting the ink pressure, means for measuring and adjusting the ink temperature, means for flushing the print head, means for circulating ink through the print head and means for damping vibrations in the ink and/or evening out variations in the ink flow velocity and/or ink pressure that may be caused by ink circulation pumps.

Ink conditioners known from the state of the art typically comprise a plurality of different parts, such as hoses, connectors and seals that are made from different materials and assembled together. As a result, the conditioners are prone to errors and/or disturbances, such as sealing leakage or clogging caused by formation of ink deposits, which can appear if the ink is incompatible with one of the materials the conditioner consists of.

The object of the invention is to provide an ink conditioner for an inkjet printer that is less prone to such errors and/or disturbances and thus improves the stability of the printing process.

The object of the invention is solved by an ink conditioner for an inkjet printer, comprising a main body with an ink damping cavity, the ink conditioner further comprising a heat transfer element, at least one ink inlet and at least one ink outlet, wherein the main body, the heat transfer element, the at least one ink inlet and the at least one ink outlet consist of the same material and form a single piece.

In this context, the term “inlet” refers to openings through which a liquid can enter the conditioner. The term “outlet” refers to openings through which a liquid can leave the conditioner.

It is conceivable that a purpose of the ink damping cavity is to damp vibrations within the ink and/or to even out ink flow velocity and/or ink pressure fluctuations. The heat transfer element can be used for adjusting the ink temperature.

The proposed conditioner structure with the different conditioner elements forming a single piece from the same material reduces the effort for assembling the conditioner. Furthermore, compared to conventional conditioners, the total number of applied individual parts and materials and thus potential points of failure is reduced.

In one embodiment, the main body, the heat transfer element, the at least one ink inlet and the at least one ink outlet are manufactured by rapid prototyping, in particular 3D printing, and consist of a metal.

The rapid prototyping and/or 3D printing technique enables to manufacture the main elements of the conditioner in a single time and cost saving processing step, even if the conditioner geometry is complex.

Preferably, the main body, the heat transfer element, the at least one ink inlet and the at least one ink outlet consist of titanium. This metal offers high hardness and excellent corrosion resistivity. Furthermore, titanium is antimagnetic and therefore not prone to interfere with electronic parts.

In a further embodiment, the ink conditioner comprises a membrane for sealing the ink damping cavity and a spring plate, wherein the membrane is located between the main body and the spring plate. The membrane is elastically deformable. If the ink pressure within the ink damping cavity fluctuates, the membrane may deflect in-and/or outwardly, such that the pressure fluctuations are damped. The spring plate stabilizes the membrane and limits the maximum deflection.

It is conceivable that the ink damping cavity has a circular shape. This allows to apply circular membranes for sealing the ink damping cavity. Due to the circular shape, the membranes deform symmetrically. This enables damping in comparably high pressure ranges and improves the process control in general.

In order achieve a very space saving design, the main body can comprise at least one linear channel with an opening inside the ink damping cavity in which a spring plate guiding element can be placed. In particular, the spring plate guidance element can be spring mounted piston pressing against the spring plate to ensure accurate and smooth spring plate movement.

In another variant, the heat transfer element comprises a cavity configured to receive a heating element and an ink channel surrounding the cavity. This enables heating of the ink without a direct contact between the ink and the heating element.

Preferably, the ink channel comprises an ink outlet configured to be directly connected to an inlet of a print head. The arrangement close to the print head increases the accuracy of the printing temperature control. Deviations between set temperature and actual printing temperature are prevented or at least minimized by the short flow path between sensor and print head.

In a further embodiment, the conditioner comprises a first pressure sensor configured to measure an ink pressure in a first pressure range inside of the ink channel and a second pressure sensor configured to measure an ink pressure in a second pressure range inside of the ink channel. In particular, the first pressure sensor may be configured to accurately measure low ink pressures up to 50 mbar. The second pressure sensor may be configured to measure high pressures up to 1 bar. This improves the overall accuracy of the ink pressure measurement and/or control over the whole application relevant pressure range.

Additionally, the ink conditioner can comprise a connection zone configured to receive a screw or bolt for connecting the ink conditioner directly to a print head. This facilitates the assembly. Furthermore, a rigid connection between conditioner and print head can be formed, which reduces the risk of leakage at the interface between both parts.

In a further variant, the conditioner comprises a valve for print head flushing. This enables fast and easy cleaning of the print head, for example to recover blocked nozzles, without the necessity to disassemble the printer and/or print unit.

Further advantages and features will become apparent from the following description of the invention and from the appended figures, which show a non-limiting exemplary embodiment of the invention and in which:

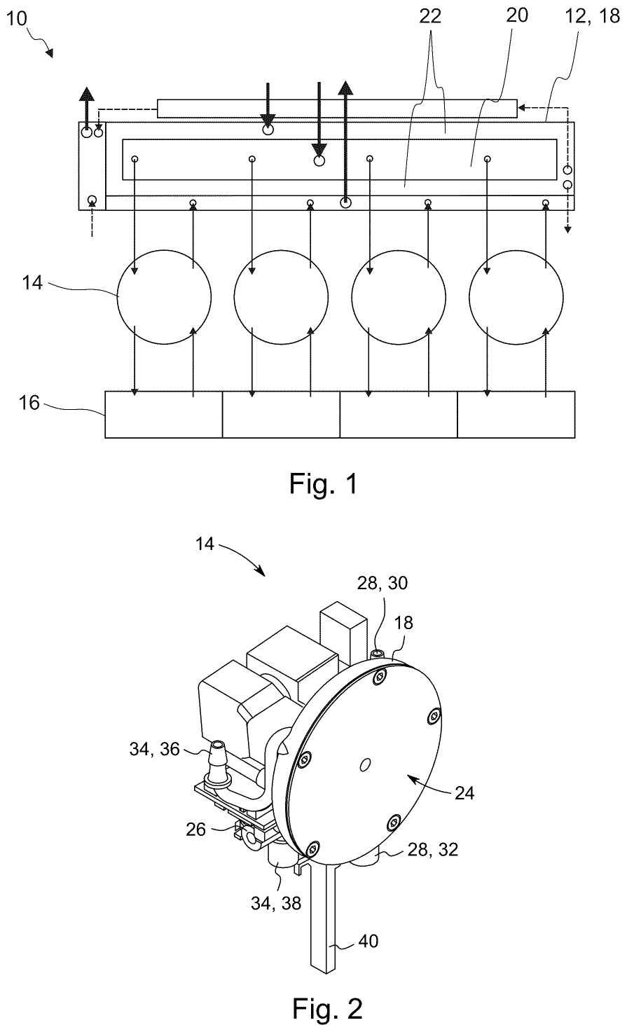

FIG. 1 schematically shows a side view of a printing unit for an inkjet printer;

FIG. 2 shows a schematic 3D illustration of an ink conditioner according to the invention;

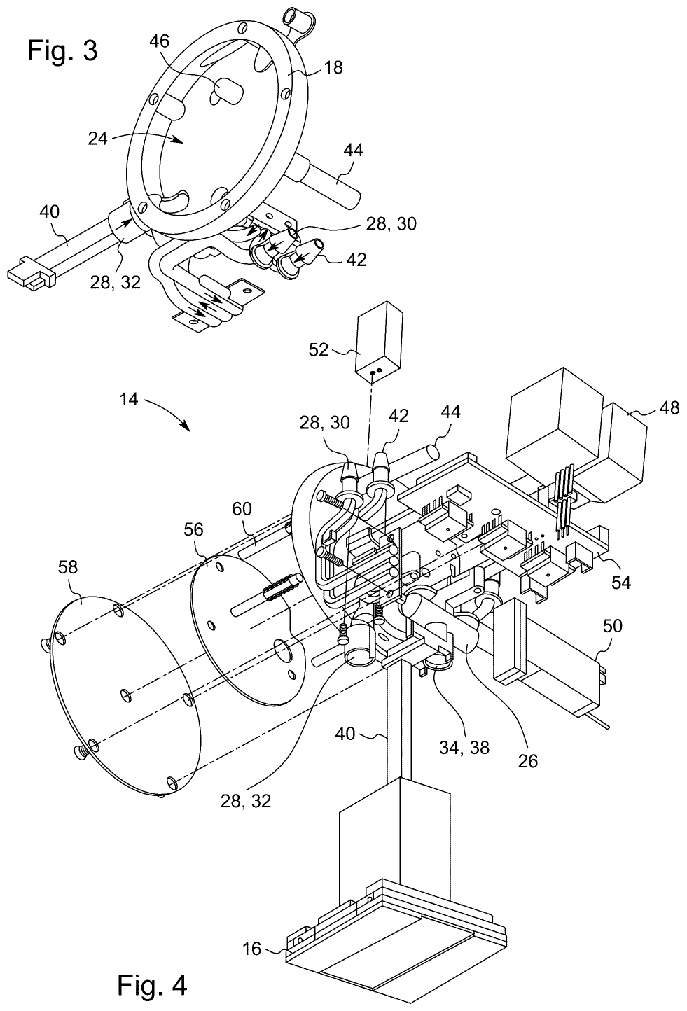

FIG. 3 shows a 3D printed piece comprised by the conditioner of FIG. 2;

FIG. 4 shows an explosion drawing of the ink conditioner of FIG. 2;

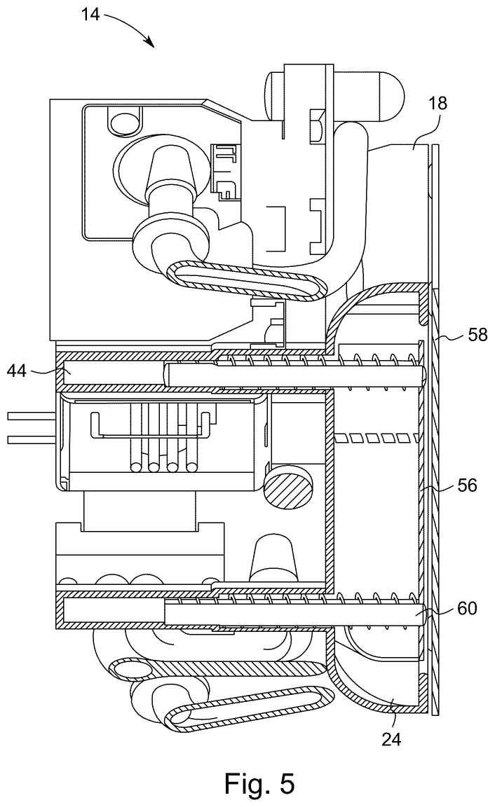

FIG. 5 shows a first cross section of the conditioner of FIG. 2; and

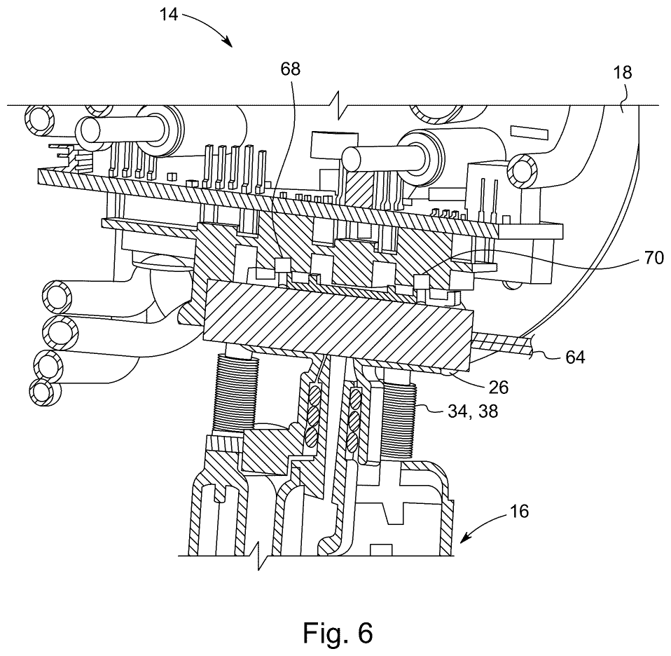

FIG. 6 shows a second cross section of conditioner of FIG. 2.

FIG. 1 schematically shows a side view of a printing unit 10 for an industrial single pass inkjet printer. It is conceivable that the inkjet printer is equipped with multiple such printing units 10, which form a stack that defines the print width of the printer.

The printing unit 10 comprises a manifold 12, four ink conditioners 14 and four piezoelectric inkjet print heads 16, for example Dimatix Samba print heads with a plurality of individually addressable nozzles arranged on a trapezoidal nozzle plate. Each conditioner 14 corresponds to an individual print head 16.

In the described embodiment, the manifold 12 comprises means to control the ink temperature, such as a main body 18 with an ink cavity 20 in thermal contact with a temperature control fluid cavity 22, as well as means to distribute the ink to the individual conditioners 14, in particular multiple inlets and outlets for the ink.

FIG. 2 shows a schematic 3D illustration of an ink conditioner 14 according to the invention, which is adapted to receive ink from the manifold 12. The conditioner 14 comprises a main body 18 with a circular ink damping cavity 24, in particular for damping circulation pump induced pressure fluctuations within the ink.

The conditioner 14 further comprises a heat transfer element 26 for fine adjustment of the ink temperature, two ink inlets 28 through which ink can enter the conditioner 14, in particular a main ink inlet 30 and an ink return inlet 32, and two ink outlets 34 through which ink can leave the conditioner 14, in particular a main ink outlet 36 and a print head feed outlet 38.

The described conditioner 14 further comprises a connection zone 40 configured to receive a screw or bolt for connecting the ink conditioner 14 directly to a print head 16.

In the described embodiment, the main body 18, the heat transfer element 26, the ink inlets 28, the ink outlets 34 and the connection zone 40 form a single piece and consist of 3D printed titanium.

A schematic 3D illustration of this single piece is shown in FIG. 3.

The single piece can comprise further elements, such as liquid inlets, for example a flush inlet 42 through which a flushing liquid for print head cleaning can enter the conditioner 14.

In the embodiment, the single piece additionally comprises three linear channels 44 with openings 46 inside the ink damping cavity 24 for receiving movable parts, in particular guiding elements.

It is conceivable that the whole structure as depicted in FIG. 3, including the main body 18, the heat transfer element 26, the ink inlets 28, the ink outlets 34, the connection zone 40, the flush inlet 42 and the three linear channels 44, is 3D printed in a single time and cost saving processing step.

Despite the high number of different elements and complexity of the structure, the single piece does not comprise any sealing or similar parts made from rubber or comparable materials. It is thus very robust and due to the inert nature of the titanium surface highly compatible with many different types of inks, in particular inks containing polar and/or nonpolar and/or organic solvents.

In the described embodiment, the conditioner 14 contains a plurality of further parts mounted to the 3D printed titanium structure.

FIG. 4 shows an explosion drawing of these ink conditioner parts, including a circulation pump 48, a valve 50 for regulating the liquid flow through the print head feed outlet 38, a valve 52 that allows print head flushing, a sealed circuit board 54, in particular for controlling the circulation pump 48 and/or the valves 50, 52.

In the described example, the circulation pump 48 is located between the ink return inlet 32 and the main ink outlet 36. Consequently, the circulating ink flows through the print head 16 before it passes the circulation pump 48.

It is conceivable that the manifold 12 forms part of the ink circulation system. As an example, the circulation pump 48 may generate an ink flow from the manifold 12 to the conditioner 14, from the conditioner 14 to the print head 16, from the print head 16 to the conditioner 14 and from the conditioner 14 back to the manifold 12.

The valve 50 can regulate and/or interrupt the ink circulation, for example if print head cleaning and/or flushing is intended.

The ink conditioner 14 further comprises a circular membrane 56 for sealing the ink damping cavity 24, a spring plate 58 and spring plate guiding elements 60.

FIG. 5 shows a first cross section of the assembled conditioner 14, in particular of the ink damping cavity 24 and corresponding parts.

The membrane 56 is elastically deformable and located between the main body 18 and the spring plate 58. If the ink pressure within the ink damping cavity 24 fluctuates, the membrane 56 may symmetrically deform and/or deflect towards and/or away from the main body 18, thereby changing the cavity volume such that the pressure fluctuations are damped. The spring plate 58 stabilizes the membrane 56 during deflection and limits it's maximum travel.

The spring plate guiding elements 60 are spring mounted pistons, which are movably seated in the linear channels 44 of the main body 18. Due to the spring mounting, the spring plate guiding elements 60 press against the membrane 56 and/or spring plate 58, thereby ensuring accurate and smooth spring plate movement. It is conceivable that the damping characteristics of the ink damping cavity 24 depend on the Young's modulus of the mounting springs and/or of the spring plate 58.

FIG. 6 shows a second cross section of the assembled conditioner 14, in particular of heat transfer element 26.

In the embodiment, the heat transfer element 26 comprises a cavity in which a heating element 64, in particular a resistive heater, is located.

The heat transfer element 26 further comprises an ink channel surrounding the heater cavity.

It is conceivable that the walls forming the heater cavity as well as the surrounding ink channel consist of 3D printed titanium with a high heat conduction coefficient. Heat generated by the heating element 64 is thus efficiently conducted towards the ink inside the ink channel.

The ink channel comprises an ink outlet, in the embodiment the print head feed outlet 38, which is directly connected to an inlet of a print head 16. It is thus possible to adjust the ink temperature of the ink directly before it enters the print head 16.

In the described example, the conditioner 14 further comprises a first pressure sensor 68 configured to measure an ink pressure in a first pressure range inside of the ink channel and a second pressure sensor 70 configured to measure an ink pressure in a second pressure range inside of the ink channel.

The use of multiple differently ranged pressure sensors 68, 70 improves the overall accuracy of the ink pressure measurement and thus the process control.

1. An ink conditioner for an inkjet printer, the ink conditioner comprising:
a main body with an ink damping cavity,
a heat transfer element,
at least one ink inlet, and
at least one ink outlet,
wherein the main body, the heat transfer element, the at least one ink inlet, and the at least one ink outlet include a same material and form a single piece.

2. The ink conditioner according to claim 1, wherein the main body, the heat transfer element, the at least one ink inlet, and the at least one ink outlet include a 3D-printed metal.

3. The ink conditioner according to claim 1, wherein the main body, the heat transfer element, the at least one ink inlet, and the at least one ink outlet include titanium.

4. The ink conditioner according to claim 1, wherein the ink damping cavity has a circular shape.

5. The ink conditioner according to claim 1, further comprising:
a membrane for sealing the ink damping cavity, and
a spring plate,
wherein the membrane is located between the main body and the spring plate.

6. The ink conditioner according to claim 1, wherein the main body comprises at least one linear channel with an opening inside the ink damping cavity configured to receive a spring plate guiding element.

7. The ink conditioner according to claim 1, wherein the heat transfer element comprises:
a cavity configured to receive a heating element, and
an ink channel surrounding the cavity.

8. The ink conditioner according to claim 7, wherein the ink channel comprises an ink outlet configured to be directly connected to an inlet of a print head.

9. The ink conditioner according to claim 7, further comprising:
a first pressure sensor configured to measure an ink pressure in a first pressure range inside of the ink channel, and
a second pressure sensor configured to measure the ink pressure in a second pressure range inside of the ink channel.

10. The ink conditioner according to claim 1, further comprising:
a connection zone configured to receive a screw or bolt for connecting the ink conditioner directly to a print head.

11. The ink conditioner according to claim 1, further comprising:
a valve for print head flushing.
